(19) United States
(12) Patent Application Publication
(10) Pub. No.: US 2026/0121268 A1
(43) Pub. Date: Apr. 30, 2026

(54) SYSTEMS AND METHODS FOR A STAGGERED INTRODUCTION MULTILAYER POUCH CELL

(71) Applicant: Ford Global Technologies, LLC, Dearborn, MI (US)

(72) Inventor: Wilhelm Siebert, White Lake, MI (US)

(21) Appl. No.: 18/933,882

(22) Filed: Oct. 31, 2024

(51) Int. Cl. H01M 50/673; H01M 10/04; H01M 50/105; H01M 50/618; H01M 50/636

(52) U.S. Cl. CPC H01M 50/673; H01M 10/0404; H01M 50/105; H01M 50/618; H01M 50/636

(57) ABSTRACT

Methods and systems are provided for manufacturing a staggered introduction multilayer pouch wherein the staggered introduction multilayer pouch is configured to release chemicals into a pouch cell battery on demand during formation, aging and testing (FA&T). In one example, a system may include a main pouch and one or more chemical pouches adjacent to the main pouch. The main pouch may include an electrode stack and include a cathode tab and an anode tab and the chemical pouches may be configured to add chemicals to the main pouch on demand. In some examples, the chemical pouches may contain electrolytes or other additives that can be added to the main pouch on demand according to the FA&T process and the chemical properties of each chemical.

### FIELD

The present description relates generally to methods and systems for manufacturing lithium ion batteries and more specifically to methods and systems to introduce one or more liquid components to a pouch-cell battery in a staggered order.

### BACKGROUND/SUMMARY

During the typical manufacture process of pouch-cell batteries, a stack of electrode sheets is placed within a manufactured multilayer pouch. The stack of electrode sheets may include a cathode tab and an anode tab. Once the stack of electrode sheets is placed within the multilayer pouch, an electrolyte solution is added to the multilayer pouch. In some examples, one or more additives may be added to the multilayer pouch at the same time as the electrolyte solution is added. The additives may include fire retardants, cold temperature performance enhancers, cycle life extenders, and others depending on the demands of the final product. These additives are added with the electrolyte and therefore may be specifically chosen for their stability during the manufacturing process, and particularly during the formation, aging and testing process (FA&T). Once the additives and electrolytes are added to the multilayer pouch, the multilayer pouch may be sealed, which may prevent further addition of chemicals to the pouch. FA&T may begin after the multilayer pouch is sealed. During formation, a solid electrolyte layer (SEI) is formed at the interface between the anode and the electrolyte.

In one example, a configuration of a staggered introduction multilayered pouch cell for an energy storage device that includes a main pouch that houses an electrode stack and at least one chemical pouch adjacent to the main pouch. At least one chemical pouch houses a chemical compound, and the at least one chemical pouch is configured to add the chemical compound to the main pouch at a controlled time. The main pouch and the chemical pouch or pouches are formed from a common sheet of multilayered pouch material. In this way, the multilayered pouch cell can be sealed from the ingress or egress of material from outside of the multilayered pouch cell during FA&T but chemicals can be added to the main pouch on command during FA&T. As one example, one or more chemical pouches include electrolyte, one or more additives, and an electrolyte refill. A mechanism such as a breakable seal or one or more sliding clamps may separate each chemical pouch from the main pouch. The seal may be broken or the one or more sliding clamps may be moved to selectively fluidically couple a chemical pouch to the main pouch on demand in order to add the chemical housed within the chemical pouch to the main pouch. The electrolyte may be added before the beginning of FA&T to facilitate the formation process. Formation may include passing an electric current through the electrolyte and may use up some of the electrolyte in the main pouch. After formation, chemical pouches including additives may be added on demand to the main pouch as well as a refill of electrolyte and lithium. This allows the chemicals to be added into the main pouch to be added precisely at appropriate times based on the chemical properties of each chemical and the FA&T process. Adding chemicals on demand may reduce chemical degradation during FA&T by allowing chemicals to be added after processes that may initiate chemical degradation or increase the rate at which chemical degradation occurs. Adding chemicals on demand also allows for chemicals to be replenished after they are used up during FA&T. The main pouch containing the electrolyte stack may remain sealed from the ingress and egress of materials not included within the chemical pouches during this process. Additionally, the gasses produced during FA&T may be collected within the chemical pouches, sealed and removed from the main pouch. Utilizing chemical pouches adjacent to the main pouch for dispensing chemicals and for collecting gas allows these functions to be performed without manufacturing additional containers, such as external chemical pouches or gas removal pouches.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a method for manufacturing a staggered introduction pouch cell battery;

FIG. 2 is a flowchart displaying a method for manufacturing a staggered introduction pouch cell battery that includes one or more chemical pouches that contain electrolytes and/or other additives.

FIG. 3 is diagram of an example staggered introduction multilayer pouch with chemical pouches.

FIG. 4 is diagram of a partially assembled staggered introduction multilayer pouch with chemical pouches open.

FIG. 5 is a diagram of a partially assembled staggered introduction multilayer pouch with the chemical pouches being filled.

FIG. 6 is a diagram of a staggered introduction multilayer pouch with the chemical pouches full of electrolytes and additives.

FIG. 7 is a diagram of a staggered introduction multilayer pouch with a chemical pouch compressed by a roller.

FIG. 8 is a diagram of a staggered introduction multilayer pouch constructed with one or more clamps configured to seal the multilayer pouch.

FIG. 9 is a diagram of a staggered introduction multilayer pouch with a clamp being moved and a roller being applied to empty the contents of a chemical pouch into a main pouch.

FIG. 10 is a diagram of a staggered introduction multilayer pouch with the contents of the chemical pouches emptied into the main pouch.

FIG. 11 is a flowchart describing a method for manufacturing a staggered introduction multilayer pouch that includes one or more self-sealing ports.

FIG. 12 is a diagram of the staggered introduction multilayer pouch that includes one or more self-sealing ports.

FIG. 13 is a diagram of the staggered introduction multilayer pouch with the self-sealing ports sealed.

### DETAILED DESCRIPTION

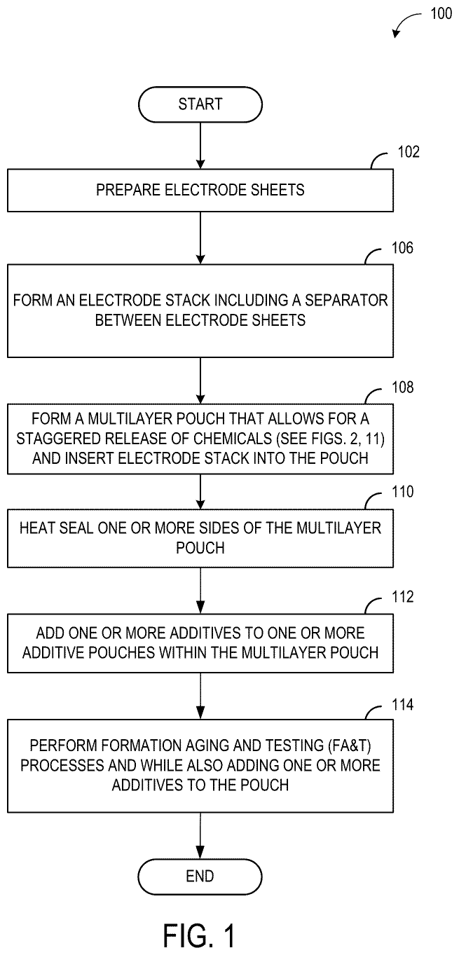

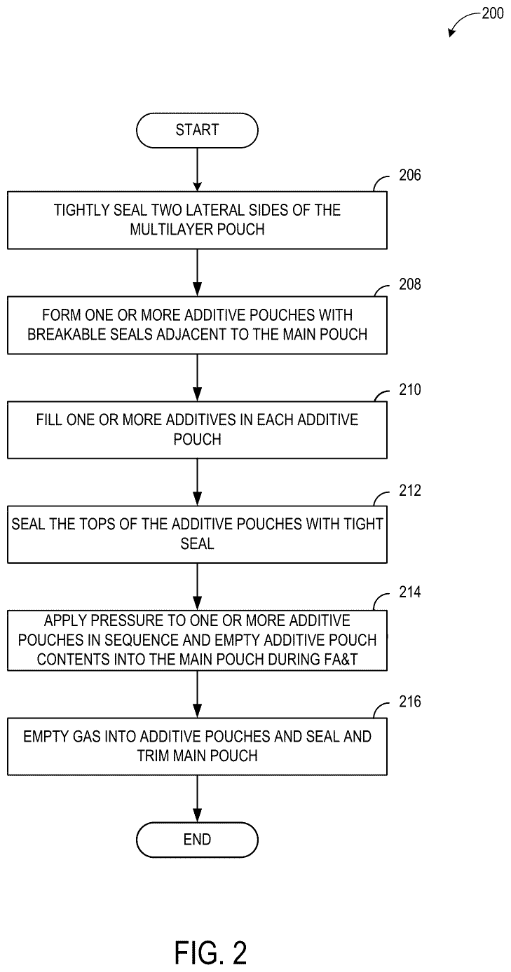

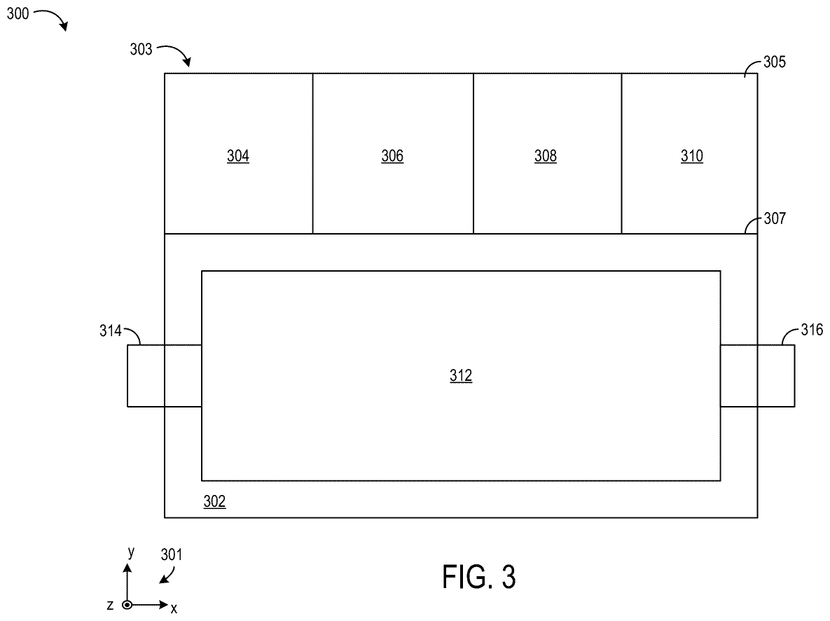

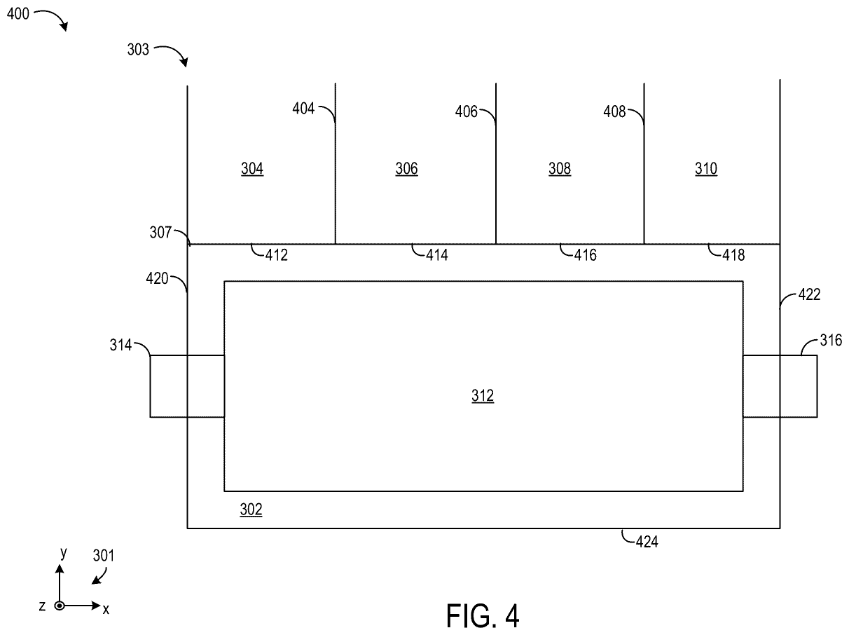

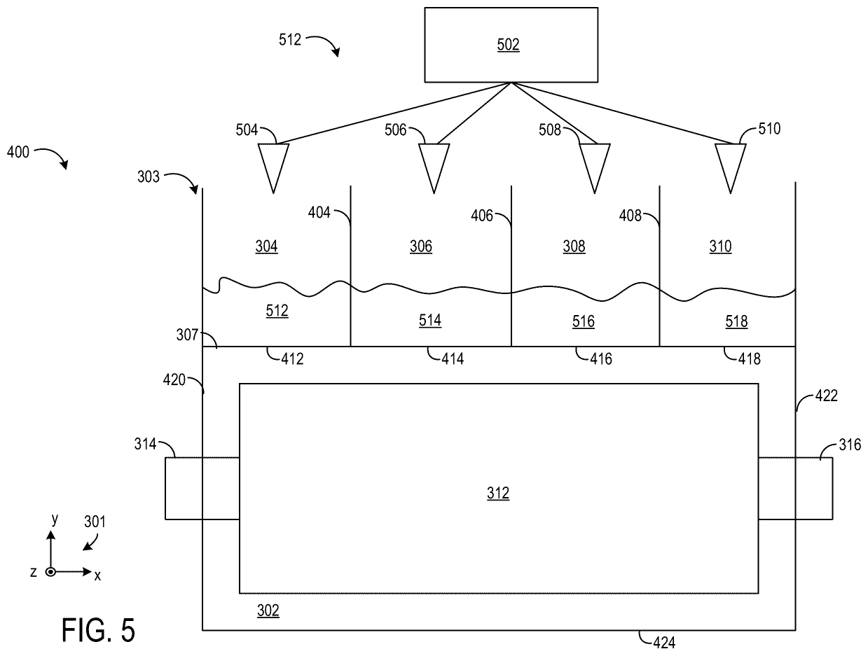

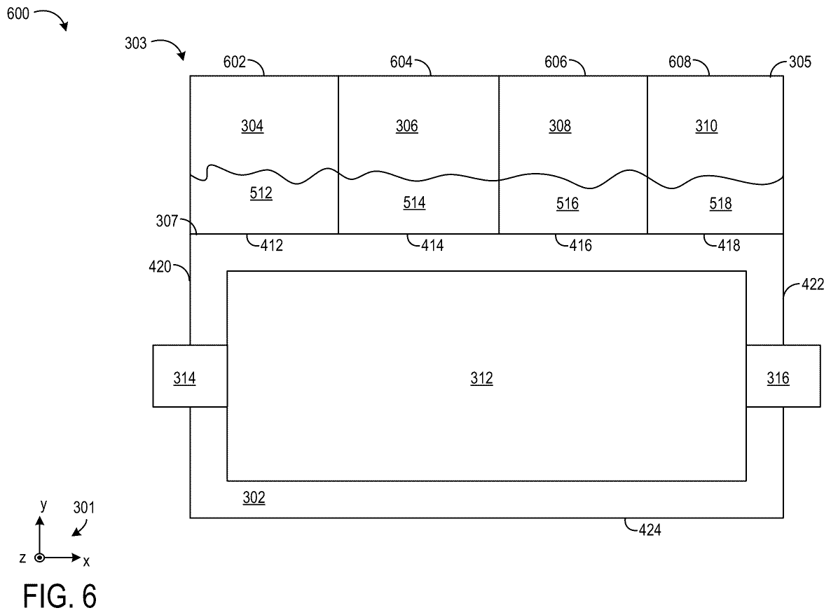

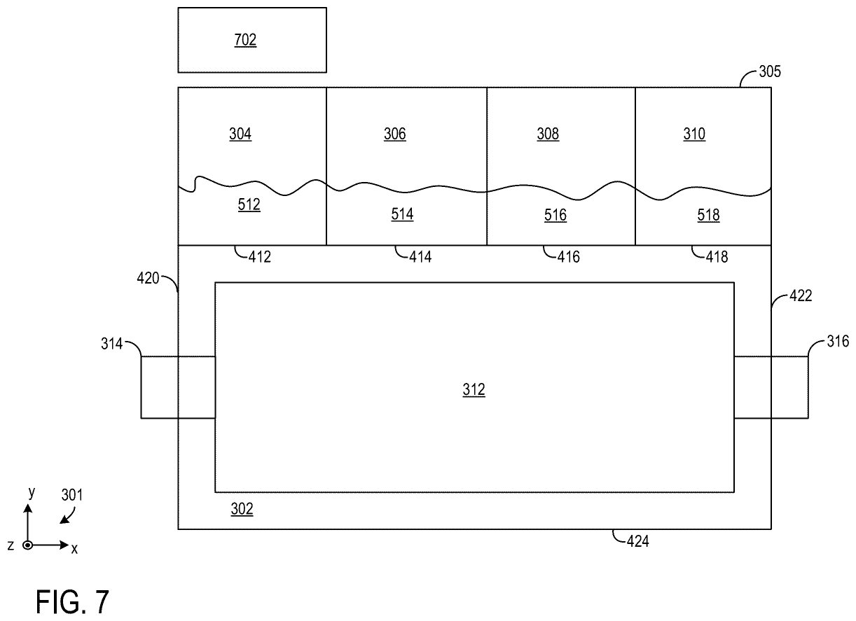

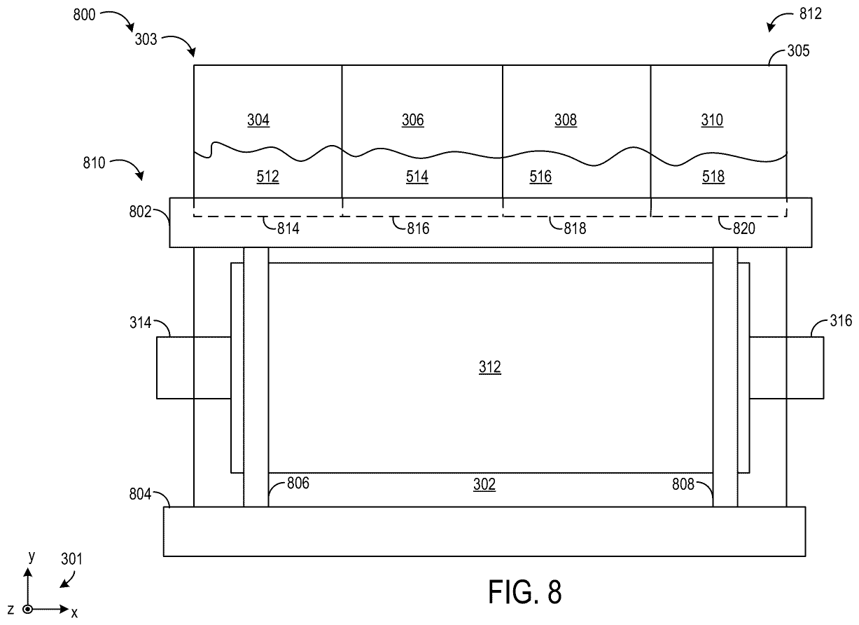

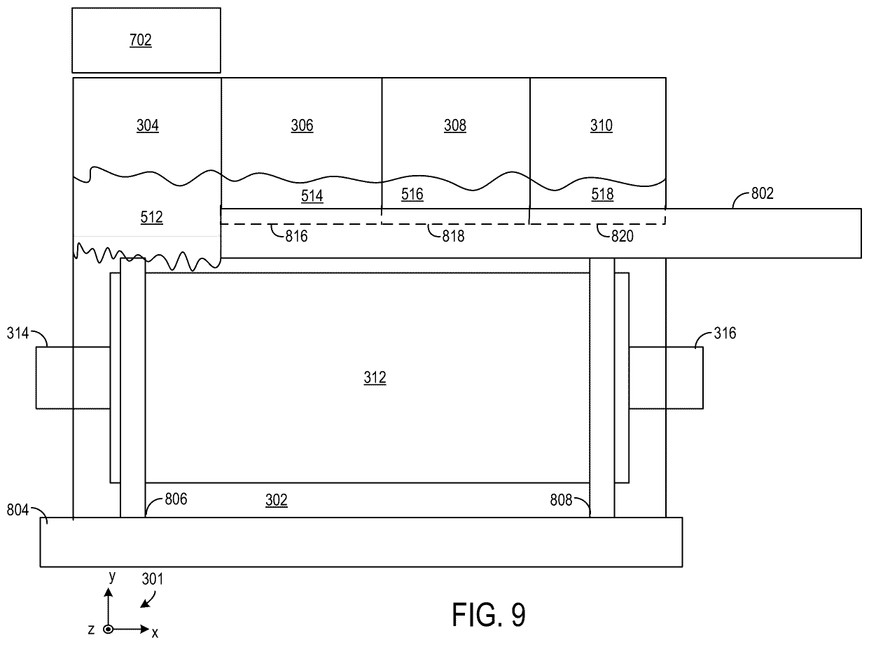

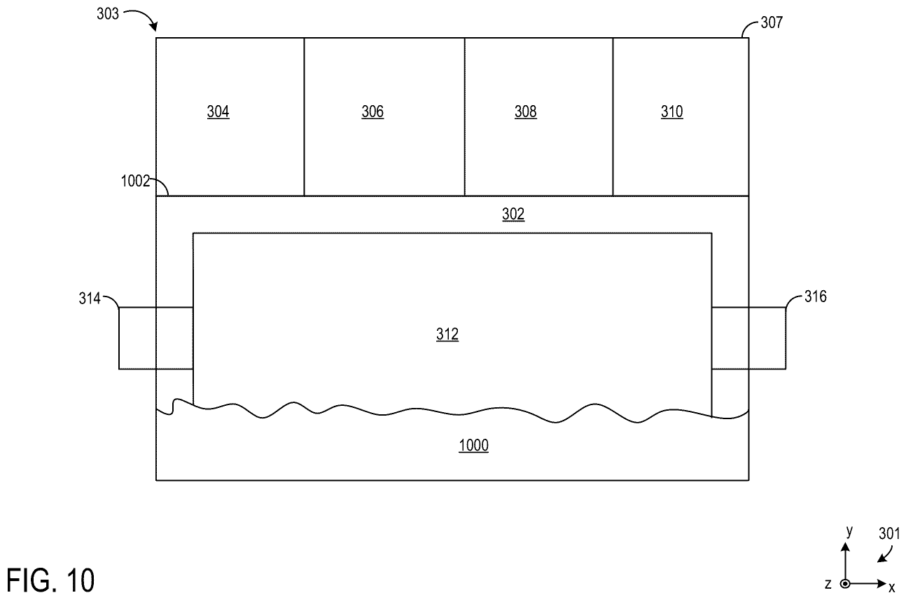

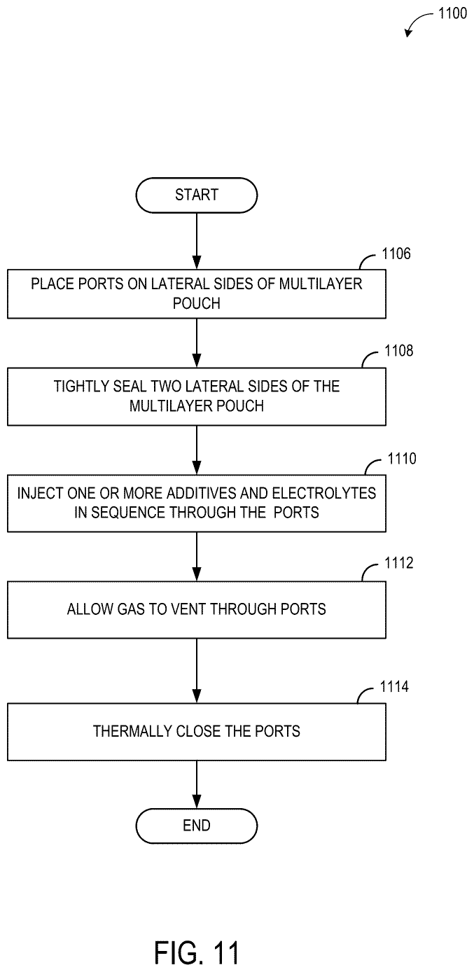

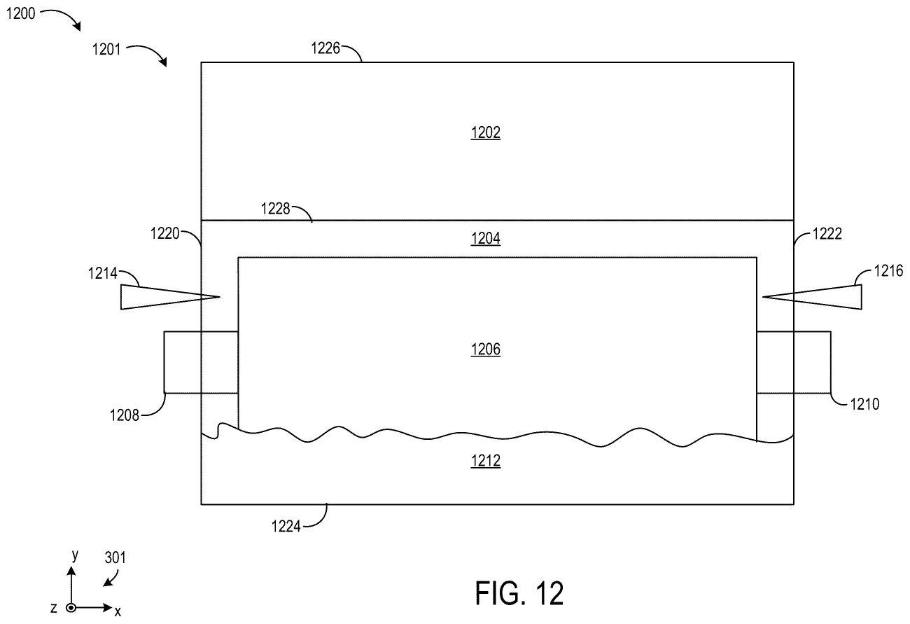

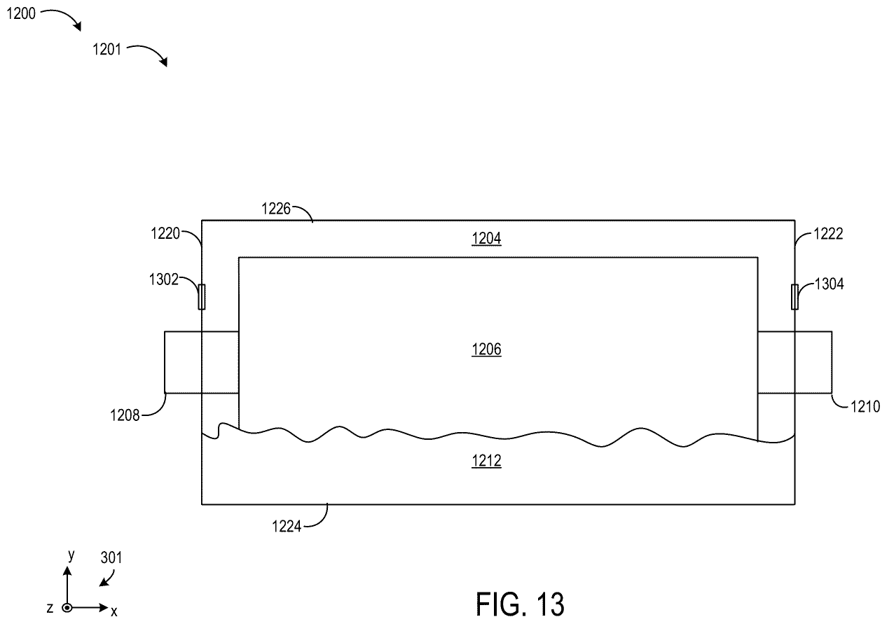

The following description relates to systems and methods that allow for delayed and/or ordered addition of chemicals to a pouch cell battery. The pouch cell battery may be a staggered introduction multilayer pouch that includes a main pouch housing (e.g., containing) a stack or roll of electrodes. The pouch cell battery may be assembled according to the method described in FIG. 1. In some examples, a staggered introduction multilayer pouch may include one or more chemical pouches positioned above the main pouch, manufactured according to the method described in FIG. 2, and shown in FIG. 3. The staggered introduction multilayer pouch may first be assembled with open chemical pouches, as shown in FIG. 4. A chemical dispenser may fill the chemical pouches with one or more chemicals as shown in FIG. 5 before the chemical pouches are sealed, as shown in FIG. 6. The chemical pouches may contain electrolytes, and/or other additive components such as fire retardants that may be added at points in time of the manufacturing process that are appropriate to the chemical reactivity of the additive. For example, the formation step of the manufacturing process for pouch cell batteries includes passing a charge through the battery to form the SEI. Some additives are not electrochemically stable and may degrade under the conditions applied during the formation step. Therefore, it may be advantageous to add those additives after the formation step has concluded. In one example, the chemical pouches may be separated from the main pouch by breakable seals that may break when pressure is applied to the chemical pouch by a roller, as shown in FIG. 7. In other examples, such as the example shown in FIG. 8, a clamp may separate the chemical pouches from the main pouch. The contents of each chemical pouch may be added to the main pouch when the clamp is removed from the bottom of the chemical pouch and pressure is applied to the chemical pouch by a roller, as shown in FIG. 9. Once emptied, the chemicals from the chemical pouches may accumulate in the main pouch, as shown in FIG. 10. In other examples, shown in FIG. 12, one or more self-sealing ports may be integrated into one or more sides of the main pouch. A staggered introduction multilayer pouch with injection ports may be manufactured according to the method shown in FIG. 11. The injection ports may be capable of allowing electrolytes and other additives to be added to the main pouch at different stages of the FA&T process but may prevent the spill of liquid out of the main pouch. The injection ports may later be sealed under heat once all additives and electrolytes have been added to the main pouch. The sealed injection ports may be shown in FIG. 13. The location of the injection ports may later serve as a location to vent gas if excessive gas is generated within the main pouch.

FIG. 1 is a flowchart that describes a method 100 as one example of a method for manufacturing a staggered introduction pouch cell battery. The method 100 may be performed by one or more manufacturing machines designed to carry out one or more functions within the method 100 and/or technicians capable of performing one or more of the functions within the method 100. The method 100 may be performed in a controlled environment to prevent moisture and/or debris from coming into contact with components of the staggered introduction pouch cell battery. At 102, the method 100 includes preparing the electrode sheets. Preparing the electrode sheets may begin by creating an electrode slurry that may include a binding agent, an active material, a conductive material, and optionally a solvent. The binding agent or solvent combines the other ingredients into a homogeneous paste, and in some examples may be polyvinylidene fluoride. The active material produces electrical energy during battery discharges. In one example, the active material is a lithium-metal oxide for the cathode and graphite for the anode. The conductive material increases the electrical conductivity of the electrode slurry and an example conductive material is graphite. The binding agent, active material and solvent may be whipped in a vacuum to form a homogenous paste free from air bubbles called a slurry. The slurry may then be added to a coater where it is poured onto a sheet of conductive metal foil. The coater scrapes excess slurry off of the conductive metal foil and dries the conductive metal foil. Once the conductive metal foil is dried, it is compressed by a rolling press and cut into a desired size and shape to form an electrode sheet. A conductive tip is left on the electrode sheet.

At 106, an electrode stack is formed. An electrode stack includes a separator that prevents electrical contact between the cathode and anode of the battery but allows ions to pass through the separator. The separator is placed between one or more layers of electrode sheets. In the electrode stack, the electrode sheets and separator are vertically stacked and may include one or more stacks containing a separator between two electrode sheets. In other examples, a jelly roll may be used in place of an electrode stack. The jelly roll may be similar to the electrode stack in that a separator is placed between layers of electrode sheets. However, a separator may be rolled between two layers to form multiple layers of electrode sheets and separator in the jelly roll. Either a jelly roll or an electrode stack may be used in a pouch cell battery, and may be selected based on the specifications of the battery. Further figures may refer to an electrode stack, however in other examples, the electrode stack may be replaced by a jelly roll.

At 108, a staggered introduction multilayer pouch that allows for a staggered introduction of chemicals is formed and the electrode stack is inserted into the staggered introduction multilayer pouch. The method for forming the staggered introduction multilayer pouch may differ depending on the design of the staggered introduction multilayer pouch. The pouch may be configured for irreversible addition of additives to the pouch. In this way, additives may be introduced in a staggered manner without later removal of additives which may cause contamination of the environment inside the pouch. For example, a method for forming a staggered introduction multilayer pouch with multiple breakable chemical pouches is be described with respect to FIG. 2. A method for forming a staggered introduction multilayer pouch, including injection ports through which additives, electrolytes, and other chemicals can be introduced to the staggered introduction multilayer pouch, is described with respect to FIG. 11. The staggered introduction multilayer pouch is formed out of a flat sheet of a material such as aluminum laminated film wherein a first face of the sheet may be configured to be in contact with the internal components of the pouch cell battery and a second face of the sheet may be configured to face externally. The sheet may be folded such that the first face faces internally and the second face faces externally and one or more sides of the sheet are heat sealed to form the staggered introduction multilayer pouch comprised of two layers of the sheet. In other examples, two separate sheets are placed on top of one another and sealed on at least one side to form a staggered introduction multilayered pouch. One or more sides of the staggered introduction multilayer pouch are left open to allow for the electrode stack to be added. The electrode stack is placed in the multilayer pouch through an unsealed side. Heat sealing may comprise applying heat to a portion of the multilayer pouch to fuse the two layers of the sheet together, forming a seal in the staggered introduction multilayer pouch. At 110, one or more portions of the staggered introduction multilayer pouch are sealed to enclose the electrode stack within the main pouch of the staggered introduction multilayer pouch. The main pouch is the portion of the staggered introduction multilayer pouch housing the electrode stack and it is the pouch that chemicals are added to.

At 112, one or more additives are optionally added to one or more chemical pouches within the staggered introduction multilayer pouch. 112 may be performed if the staggered introduction multilayer pouch is formed according to the method described with respect to FIG. 2, wherein multiple breakable pouches are formed above the main pouch. Additives are added to the chemical pouches, and then the chemical pouches are sealed, but the seal to the main pouch may be broken to fluidically couple the main pouch and a chemical pouch to release additives into the main pouch on demand. In the example that the main pouch is formed according to the method described with respect to FIGS. 11, 112 may be skipped and the method may proceed to 114.

At 114, the method 100 includes performing formation, aging, and testing (FA&T) processes on the pouch cell battery, while also adding one or more additives to the pouch. Formation may include passing a current through the battery for the first time and forming a solid electrolyte interphase (SEI) layer on the interface between the anode and the electrolyte within the main pouch. Aging may include allowing a manufactured battery to age, which may include waiting for chemical reactions that occur during manufacturing to cease. Testing may include testing the power output of the battery, testing the strength of the seals included in the pouch cell battery, and/or a variety of other tests. Due to the electrochemical stability of some additives, the additives may degrade during the formation stage. Chemicals may be introduced to the main pouch in a staggered manner to allow chemicals to be added at the optimal stage of FA&T depending on the chemical properties of each additive and the FA&T process. Staggering the introduction of chemicals cannot be performed with a conventional pouch of a pouch cell battery because a conventional pouch is fully sealed before FA&T begins. No chemicals can be introduced to a fully sealed conventional pouch without breaking the seals of the conventional pouch between the interior of the conventional pouch and the exterior of the conventional pouch.

The staggered introduction multilayer pouch described herein allows for chemicals to be introduced to the main pouch on demand without breaking the seals that separate the interior of the staggered introduction multilayer pouch from the exterior of the staggered introduction multilayer pouch. This allows FA&T to be performed in a typical manner while allowing chemicals to be added on demand during FA&T. In one example, a starter amount of electrolyte may be introduced to the main pouch before the formation process and a refill amount of electrolyte may be introduced to the main pouch after the formation process to compensate for the electrolyte lost during FA&T. After 114, method 100 ends.

FIG. 2 is a flowchart depicting a method 200 for manufacturing a pouch cell battery that includes one or more chemical pouches, such as the staggered introduction multilayer pouch 303 described with respect to FIG. 3. The method 200 is performed at 108 of method 100. As described above with respect to 108, a staggered introduction multilayer pouch is constructed that allows for the staggered release of chemicals into a main pouch. After starting method 200 proceeds to 206.

At 206, the method 200 may include tightly sealing a first side and a second side of the staggered introduction multilayer pouch. The first side and the second side may be vertical sides parallel to each other and positioned on opposite sides of the staggered introduction multilayer pouch. The staggered introduction multilayer pouch may have a first side, a second side, a third side, and a fourth side. The third side and the fourth side may be horizontal sides parallel to each other and positioned on opposite sides of the staggered introduction multilayer pouch. The third side and the fourth side may be perpendicular to the first side and the second side. In some examples, the third side may be positioned below the fourth side relative to a vertical axis. The third side may be sealed during the construction of the staggered introduction multilayer pouch, and the electrode stack is placed within the staggered introduction multilayer pouch after the bottom is sealed. At the conclusion of 206, the staggered introduction multilayer pouch may be a pouch sealed on the first side, second side, and third side and open on the fourth side. The staggered introduction multilayer pouch contains the electrode stack at 206. At 208, the method includes forming one or more chemical pouches with breakable seals adjacent to the main pouch. The main pouch may comprise a portion of the multilayer pouch that contains the electrode stack and includes space for the addition of chemicals. Chemical pouches may be positioned adjacent to the main pouch and may be constructed by creating one or more tight vertical seals parallel to the first side and the second side. The tight vertical seals may extend a height from the fourth side towards the third side. A tight seal may be a fluid tight seal, impermeable to gas and liquid, and prevented from breaking under the application of pressure used to break the breakable seals. The tight vertical seals may prevent any chemicals added to the chemical pouch from leaking into adjacent chemical pouches. In a first example, a bottom to each chemical pouch may be added by creating a breakable seal that separates each chemical pouch from the main pouch. The breakable seals may be created using heat sealing on a lower heat setting or by applying heat for a shorter duration than is used for creating the fluid tight seals. In a second example, a bottom to each chemical pouch may be added by applying one or more sliding clamps between the main pouch and the chemical pouches. The one or more sliding clamps may be moved or removed to fluidically couple one or more chemical pouches to the main pouch. The chemical pouches may remain open at the top of each chemical pouch along the fourth side. At 210, the method 200 includes filling each chemical pouch with one or more additives or electrolytes. The staggered introduction multilayer pouch may be weighed during this process and a mass of additive or electrolyte may be added to each chemical pouch depending on how much of each additive or electrolyte is used in the construction of the pouch battery. In some examples, the additives may be liquid, such as an electrolyte solution, however, solid additives are also possible.

At 212, the openings of each chemical pouch along the fourth side are sealed with a fluid tight seal to enclose the additives or electrolytes within each chemical pouch. 212 may be one example of the additive process described at 112 of the method 100. At 214 pressure is applied to one or more chemical pouches in sequence to empty the contents of each chemical pouch into the main pouch. A roller may apply pressure to each chemical pouch creating pressure within the chemical pouch that breaks the breakable seal at the bottom of each chemical pouch. In some examples, a clamp may be used to seal the bottom of the chemical pouch, and the clamp may be moved to empty each chemical pouch while the roller ensures all of the additive material is evacuated from the chemical pouch. This may occur during FA&T described with respect to 114 of method 100. Each chemical pouch may be emptied at a step of FA&T particular to the chemical properties of the additive and the requirements of the FA&T process. For example, a fire retardant that is electrochemically unstable may be added after the formation process.

At 216 all of the additives have been added to the main pouch and FA&T has concluded. The addition of chemicals and the FA&T process produce gas during chemical reactions. The multilayer pouch may be positioned so that these gasses fill the chemical pouches when they are released. A tight heat seal is then created between the main pouch and the chemical pouch, and the chemical pouch is trimmed away from the main pouch. The chemical pouch and the gasses within it may then be disposed of, leaving a fully assembled pouch cell battery in the main pouch. After 216, method 200 ends.

FIG. 3 is a schematic diagram of a pouch cell battery 300 assembled according to the method 200. The pouch cell battery 300 may be described with respect to a Cartesian coordinate system 301. The Cartesian coordinate system may include a y-axis is parallel to the vertical dimension of components within the pouch cell battery. Top and above may refer to components in a positive y position relative to other components, while bottom and below may refer to components in a negative y position relative to other components. Height may be used to describe the extent of a component parallel to the y-axis. The x-axis is parallel to the longitudinal direction and width may describe the extent of a component parallel to the x-axis. The z-axis may define the thickness of a component.

A staggered introduction multilayer pouch 303 is formed at 208 of the method 200 that includes a main pouch 302, a first chemical pouch 304, a second chemical pouch 306, a third chemical pouch 308, and a fourth chemical pouch 310. The staggered introduction multilayer pouch 303 may include at least one chemical pouch and other numbers of pouches in addition to the four pouches shown in FIG. 3 are also considered in the scope of the disclosure.

The main pouch 302 may have a width along the x-axis equal to the combined width along the x-axis of the first chemical pouch 304, the second chemical pouch 306, the third chemical pouch 308, and the fourth chemical pouch 310. In some examples the first chemical pouch 304, the second chemical pouch 306, the third chemical pouch 308, the fourth chemical pouch 310, and other chemical pouches of the pouch cell battery 300 may have the same width. In other examples, the first chemical pouch 304, the second chemical pouch 306, the third chemical pouch 308, the fourth chemical pouch 310, and other chemical pouches of the pouch cell battery 300 may have variable widths to accommodate different volumes of additives. For example, if a large volume of initial electrolyte is required, a chemical pouch containing initial electrolyte may be wider than a chemical pouch containing a smaller volume of additive. In some examples, each chemical pouch has the same height, and a main pouch top 307 separates the main pouch 302 from the chemical pouches. In some examples, the main pouch top 307 includes one or more smaller breakable seals, with each smaller breakable seal configured to fluidically couple the chemical pouches to the main pouch 302 once the breakable seal has been broken. The main pouch top 307 may extend a width along the x-axis along the top 305 of the staggered introduction multilayer pouch 303. An electrode stack 312 may be placed within the main pouch 302. In some examples, the electrode stack 312 may be a jelly roll. The electrode stack 312 may be coupled to an anode tab 314 and a cathode tab 316 that each extend through the vertical sides of the staggered introduction multilayer pouch 303. The vertical sides of the staggered introduction multilayer pouch 303 may be sealed around the anode tab 314 and the cathode tab 316 in such a way that materials sealed within the main pouch 302 cannot leak from the main pouch 302 to the surrounding environment.

FIG. 4 is a diagram of a fillable staggered introduction pouch cell battery 400 at the stage in the manufacturing process described at 208 of the method 200. In some examples, the bottom seal 424 may be a fold instead of a seal. The bottom seal 424 may be applied at 108 of the method 100. There may be a first vertical side seal 420 and a second vertical side seal 422 that are each sealed at 206 of the method 200. The first vertical side seal 420 may be sealed around the anode tab 314 and the second vertical side seal 422 may be tightly sealed around the cathode tab 316 in such a way that neither gas nor liquid can exit or enter the staggered introduction multilayer pouch 303 through the first vertical side seal 420 or the second vertical side seal 422. The first vertical side seal 420 and the second vertical side seal 422 may extend the entire height along the y-axis of the staggered introduction multilayer pouch 303. There may be a first vertical seal 404, a second vertical seal 406, and a third vertical seal 408, that extend a height along the y-axis from a multilayer pouch top 305 of the staggered introduction multilayer pouch 303. In some examples, each vertical seal may extend the same height along the y-axis from the multilayer pouch top 305 of the staggered introduction multilayer pouch 303. Each vertical seal may be a fluid tight seal that separates chemical pouches. A breakable seal, such as a first breakable seal 412, may form a bottom of each chemical pouch and a portion of the main pouch top 307. The breakable seals may be opened when force is applied to the chemical pouch, which may empty the contents of the chemical pouch into the main pouch 302. The first chemical pouch 304 includes a left side formed by the first vertical side seal 420, a right side formed by the first vertical seal 404, and a bottom formed by a first breakable seal 412. The second chemical pouch 306 includes a left side formed by the first vertical seal 404, a right side formed by the second vertical seal 406, and a bottom formed by a second breakable seal 414. The third chemical pouch 308 includes a left side formed by the second vertical seal 406, a right side formed by the third vertical seal 408, and a bottom formed by a third breakable seal 416. The fourth chemical pouch 310 includes a left side formed by the third vertical seal 408, a right side formed by the second vertical side seal 422, and a bottom formed by a fourth breakable seal 418. Each chemical pouch may have an open top at this stage in manufacturing.

FIG. 5 is a schematic diagram that depicts a fillable staggered introduction pouch cell battery 400 wherein the fillable staggered introduction pouch cell battery 400 is at 210 of the method 200, wherein the chemical pouches of the fillable staggered introduction pouch cell battery 400 are filled. At the stage in manufacturing shown via FIG. 5, the pouch cell battery is positioned below a filling machine 502.

The filling machine 502 may include a first dispenser 504, a second dispenser 506, a third dispenser 508, and a fourth dispenser 510. The filling machine 502 may be configured to store and dispense individual chemicals to each of the dispensers. In some examples, multiple filling machines may accomplish the function of the filling machine 502. The first dispenser 504 may be configured to dispense a first chemical 512 to the first chemical pouch 304, the second dispenser 506 may be configured to dispense a second chemical 514 to the second chemical pouch 306, the third dispenser 508 may be configured to dispense a third chemical 516 to the third chemical pouch 308 and a fourth dispenser 510 may be configured to dispense a fourth chemical 518 to the fourth chemical pouch 310.

The chemicals may be added to chemical pouches via the dispensers one at a time. In one example, the first chemical 512 may be dispensed first, followed by the second chemical 514, the third chemical 516, and the fourth chemical 518. In some examples, the first chemical 512 is an electrolyte. In some examples, the fillable staggered introduction pouch cell battery 400 is positioned on a scale, so that the mass of each chemical added to each chemical pouch can be accurately determined. In some examples, once a measured mass of chemical is added to a pouch, the dispenser associated with the pouch ceases to dispense chemical. For example, the scale has measured that a target mass of the first chemical 512 has been added to the first chemical pouch 304, the first dispenser 504 may shut off. The tops of each chemical pouch may be sealed once a predetermined mass of each additive or electrolyte has been added to each chemical pouch. In some examples, each chemical pouch may be sealed once the appropriate amount of chemical has been added to the chemical pouch before another chemical pouch is filled. For example, the first chemical pouch 304 may be filled and sealed before the second chemical pouch 306 is filled and sealed. In other examples, all of the chemical pouches may be filled and then all of the chemical pouches may be sealed.

FIG. 6 is a diagram of a sealed staggered introduction pouch cell battery 600. The sealed staggered introduction pouch cell battery 600 may be formed at 212 of the method 200 wherein the chemical pouches of the fillable staggered introduction pouch cell battery 400 are sealed. The first chemical pouch 304 may be sealed by a top seal 602, the second chemical pouch 306 may be sealed by a second top seal 604, the third chemical pouch 308 may be sealed by a third top seal 606, and the fourth chemical pouch may be sealed by a fourth top seal 608. As described above, the first top seals may be applied in any order; in some examples the top seals may be applied individually and in some examples they may form a single continuous top seal applied simultaneously to all of the chemical pouches.

FIG. 7 is a diagram of the sealed staggered introduction pouch cell battery 600 at 214 of the method 200 wherein a roller is applied to one or more chemical pouches to empty the contents of the chemical pouches in to the main pouch 302. In this example, a roller 702 is applied to the first chemical pouch 304. In some examples the roller may be configured to have the same width along the x-axis as the first chemical pouch 304. In some examples, the roller may provide pressure to the first chemical pouch 304. When sufficient pressure is applied to the first pouch, the first breakable seal 412 may break, and release the first chemical 512 into the main pouch 302. The roller 702 may be operated in such a way that it is applied to each chemical pouch during a desired time for the chemical within the chemical pouch to be released into the main pouch during FA&T. For example, the first chemical 512 may be an electrolyte that is released just prior to the beginning of formation. After formation occurs, the roller 702 may be applied to the second chemical pouch 306 to release the second chemical 514 into the main pouch 302. The second chemical 514 may be an electrolyte refill to replenish the electrolyte consumed during formation. In some examples, the roller may be applied to the first chemical pouch 304 followed by the second chemical pouch 306, the third chemical pouch 308, and the fourth chemical pouch 310, however other orders are possible.

FIG. 8 depicts an alternative arrangement for a pouch cell battery 800 assembled according to the method 200 of FIG. 2. The pouch cell battery 800 may be assembled with a one or more clamps in addition to or as a replacement for one or more seals, such as the bottom seal 424, the first breakable seal 412, the second breakable seal 414, the third breakable seal 416, and the fourth breakable seal 418. The pouch cell battery 800 may include a clamp apparatus 810 that includes a sliding clamp 802, a bottom clamp 804, a first cross bar 806, and a second cross bar 808. In one example, the clamp apparatus 810 may be coupled to the multilayer pouch at 108 during the manufacture of the staggered introduction multilayer pouch and after the electrode stack has been inserted into the main pouch 302. The clamp apparatus 810 may be affixed to the exterior of the pouch cell battery 800. The first cross bar 806 and the second cross bar 808 may be positioned vertically across the electrode stack 312. In some examples, the first cross bar 806 and the second cross bar 808 may couple the bottom clamp 804 to the sliding clamp 802. The bottom clamp 804 may be affixed over the bottom of the staggered introduction multilayer pouch 303 and have a width along the x-axis slightly greater than the width of the staggered introduction multilayer pouch 303. The bottom clamp 804 may include a first clamp piece on the front 812 of the pouch cell battery 800, and a second clamp piece on the back of the pouch cell battery. The back of the pouch cell battery 800 may be the view of the pouch cell battery 800 from the -z direction (e.g., the negative z direction), as opposed to the front 812, which is the view of the pouch cell battery 800 from the +z direction (e.g., the positive z direction). A portion of the main pouch 302 may be between the first clamp piece and the second clamp piece and the first clamp piece and the second clamp piece may be firmly coupled to create a clamped seal. The sliding clamp 802 may be similar to the bottom clamp 804 in that it includes a first clamp piece on the front 812 of the staggered introduction multilayer pouch 303 and a second clamp piece on the back of the staggered introduction multilayer pouch 303. The sliding clamp 802 may create a clamped seal across the top of the main pouch 302. The sliding clamp 802 may have the same width along the x-axis as the bottom clamp 804.

The sliding clamp 802 may replace the first breakable seal 412, the second breakable seal 414, the third breakable seal 416, and the fourth breakable seal 418 of the fillable staggered introduction pouch cell battery 400. The sliding clamp 802 may be configured to translate in the longitudinal direction along the x-axis to unseal the bottom of each chemical pouch and selectively fluidically couple each chemical pouch to the main pouch one at a time, as shown in FIG. 9. In some examples, the sliding clamp 802 may be replaced by one or more clamps, wherein each clamp replaces a single breakable seal. In some examples the clamps may be unclamped to selectively, fluidically couple the respective chemical pouch to the main pouch. Additionally or alternatively, one or more clamps may be sliding clamps. For example, a first sliding clamp 814 may replace the first breakable seal 412, a second sliding clamp 816 may replace the second breakable seal 414, a third sliding clamp 818 may replace the third breakable seal 416, and a fourth sliding clamp 820 may replace the fourth breakable seal 418. Each sliding clamp may be removed to empty the contents of the corresponding chemical pouch into the main pouch 302. For example, the third sliding clamp 818 may be removed to empty the contents of the third chemical pouch 308 into the main pouch 302.

In FIG. 9, each chemical pouch has been filled according to the method 200 of FIG. 2, and it is time for the first chemical 512 to be added to the main pouch. To introduce the first chemical 512 to the main pouch 302, the sliding clamp 802 has been translated in the +x direction (e.g., positive x direction) to remove the seal on the bottom of the first chemical pouch 304. The roller 702 applies pressure to the first chemical pouch 304 to ensure all of the first chemical 512 is evacuated from the first chemical pouch 304 into the main pouch 302. Each chemical may be added to the main pouch at different times during the FA&T process, and the sliding clamp 802 may be translated in the +x direction to open the bottom of each chemical pouch to add the chemicals to the main pouch. In another example, the first sliding clamp 814 has been removed from the first chemical pouch 304 to introduce the first chemical 512 to the main pouch 302. The roller 702 is still applied to first chemical pouch to evacuate all of the first chemical 512 from the first chemical pouch 304.

Whether chemicals are added to the main pouch 302 via breakable seals as shown in FIGS. 4-77, or via the sliding clamp 802 shown in FIGS. 8-9, the first chemical 512, the second chemical 514, the third chemical 516 and the fourth chemical 518 are all added into the main pouch 302 as shown in FIG. 10.

In FIG. 10 a chemical mix 1000 composed of the first chemical 512, the second chemical 514, the third chemical 516 and the fourth chemical 518 collects within the main pouch 302. The reactions between the chemicals and the FA&T process may produce gasses as a byproduct. The staggered introduction multilayer pouch 303 may be positioned so that the gasses are collected in the first chemical pouch 304, the second chemical pouch 306, the third chemical pouch 308, and the fourth chemical pouch 310. Once gasses are collected in the chemical pouches, a gas seal 1002 may be applied to separate the main pouch 302 from the chemical pouches. The gas seal 1002 may be an airtight seal produced by heat sealing. In this way, some of the gas produced during FA&T is sealed within the chemical pouches. The chemical pouches may then be trimmed along the gas seal 1002 to separate the chemical pouches from the main pouch 302. The chemical pouches, such as the first chemical pouch 304, the second chemical pouch 306, the third chemical pouch 308, and the fourth chemical pouch 310, may then be disposed of, and the main pouch 302 forms a fully assembled pouch cell battery.

An alternate method for assembling a pouch cell battery is described with respect to FIG. 11. FIG. 11 is a flowchart that depicts a method 1100 for manufacturing a pouch cell battery that includes one or more injection ports through which chemicals can be added during FA&T. In some examples one injection port is added to the pouch cell battery; however, other examples may include two injection ports. The method 1100 may be executed at 108 of the method 100, wherein the staggered introduction multilayer pouch is formed and the electrode stack is added to the staggered introduction multilayer pouch. At 1106, the method 1100 includes placing an injection ports on each vertical side of the staggered introduction multilayer pouch. The method 1100 may describe the method of adding two injection ports to the pouch cell battery, but in some examples, the method 1100 may be adjusted for one injection port or other numbers of injections ports to be added to the pouch cell battery. The injection ports may be placed between the two layers of the sheet that makes up the staggered introduction multilayer pouch and may be positioned slightly above the cathode and anode of the pouch cell battery with respect to the y-axis. The injection ports may be self-sealing and heat resistant.

At 1108, the vertical sides of the staggered introduction multilayer pouch are sealed at a main pouch sealing temperature. The injection ports may be held in place while the sealing process occurs. In some examples, an outer surface of the ports (e.g., the surface in face sharing contact with the main pouch) may be coated with an adhesive configure to make a fluid tight seal with the main pouch. The injection ports may be heat resistant at the main pouch sealing temperature in such a way that the heat sealing process that seals the vertical sides does not impact the injection ports, but allows the vertical sides to be tightly sealed around the injection ports and the cathode and anode. The fluid tight seals may prevent gas and liquid from entering or exiting the staggered introduction multilayer pouch. In some examples, a kind of plastic may be applied to the outer layer of the port to create a sealing bond with the pouch that further seals the interface between the ports and the pouch. The staggered introduction multilayer pouch may have a bottom, top, and two vertical sides. The bottom may be sealed during the formation of the staggered introduction multilayer pouch, and the electrode stack may be placed within the staggered introduction multilayer pouch. At the conclusion of 1108, the staggered introduction multilayer pouch may be a pouch sealed on three sides and open on the top. The electrode stack may be inserted through the open top and a heat seal may be applied to the top so that the chemicals may enter or leave the pouch through the injection ports. In some examples, the injection ports may be the only aperture for ingress or egress of materials into the staggered introduction multilayer pouch.

At 1110 one or more additives or electrolytes are injected in sequence to the staggered introduction multilayer pouch through the injection ports. The additives and electrolytes may be injected during FA&T and the time each chemical is injected may depend on the properties of the chemical. The staggered introduction multilayer pouch may be moved to an electrolyte filling station where electrolyte is added to the staggered introduction multilayer pouch through one or more of the injection ports. The electrolyte filling station may be similar to the filling machine 502 in that the electrolyte filing station contains one or more dispensers, wherein each dispenser is configured to dispense one or more chemicals. In the embodiment where the electrolyte filling station is used to dispense chemicals through the injection ports, each dispenser may include a nozzle configured to couple to the injection ports. The nozzles may be configured to deliver chemicals through the injection ports without spilling chemicals. In some examples, each dispenser may include two nozzles, a first nozzle configured to couple to a first injection port and a second nozzle configured to couple to a second injection port. Dispensing chemicals through two injection ports at once may allow chemicals to be delivered to the staggered introduction multilayer pouch at a faster rate compared to dispensing chemicals through a single injection port. FA&T may be performed following the addition of electrolytes and chemicals such as fire retardants, additives, and refill electrolytes may be added to the pouch.

At 1112, the method 1100 includes allowing gas to vent through the ports. During FA&T gas may be produced as a byproduct of the various chemical reactions involved in FA&T. To prevent bloating, this gas may be removed from the pouch cell before the manufacturing process is complete. Rather than trapping the gas in a pouch, then sealing and removing the pouch, gas may escape the pouch through the injection ports. In some examples, one or more steps of FA&T may be performed in a vacuum. In some examples, the gas that exits the pouch through the injection ports may be captured and disposed.

At 1114 the method 1100 includes thermally closing the injection ports. The injection ports may be configured to seal under the application of a port sealing temperature. The port sealing temperature may be higher than the main pouch sealing temperature used to form fluid tight seals of the main pouch. Once the injection ports are sealed, material may be prevented from exiting or entering the pouch. Excess material may be trimmed from the injection ports before or after they are sealed. Once sealed, the injection ports may be used as a predetermined breaking point. If the pouch cell requires service, or has reached the end of its lifespan, the sealed injection ports may be opened as an initial point of destructive entry into the pouch cell. In other examples, the sealed ports may be opened to vent gas produced during normal use of a pouch cell battery if a threshold pressure inside the main pouch is exceeded, or to inject an inhibitor into the pouch cell before it is opened.

FIG. 12 is an example of a pouch cell battery 1200 assembled according to the method 1100. The pouch cell battery 1200 may include a staggered introduction multilayer pouch 1201. The staggered introduction multilayer pouch 1201 may be rectangular in shape and may include two layers of material sealed together at one or more sides of the staggered introduction multilayer pouch 1201. The staggered introduction multilayer pouch 1201 may include a main pouch 1204, and in some examples may optionally include an upper pouch 1202. The upper pouch 1202 may be adjacent to the main pouch 1204 and may be configured to capture gas produced during FA&T. In alternate examples, staggered introduction multilayer pouch 1201 may not include upper pouch 1202 and gas produced during FA&T may be evacuated through a port (e.g., first port 1214 and/or second port 1216).

The main pouch 1204 may be rectangular in shape and include a bottom seal 1224, a top seal 1226, a first vertical side seal 1220 and a second vertical side seal 1222. The bottom seal 1224 may be parallel to the top seal 1226 and may be identical in length to the top seal 1226. The first vertical side seal 1220 may be parallel to the second vertical side seal 1222 and identical in height to the first vertical side seal 1220. The first vertical side seal 1220 may be perpendicular to the bottom seal 1224. The first vertical side seal 1220, the second vertical side seal 1222 and the top seal 1226 may be formed via heat sealing that fuses the two layers of material that make up the staggered introduction multilayer pouch 1201. The bottom seal 1224 may be formed via heat sealing, or it may be a fold in a sheet of material that makes up the staggered introduction multilayer pouch 1201.

In some examples, the upper pouch may include a top seal 1226 shared with the main pouch 1204, and may share the first vertical side 1220 and the second vertical side 1222 with the main pouch 1204. The main pouch may further include a gas seal 1228 parallel to the top seal 1226. The gas seal 1228 may be positioned below the top seal 1226 relative to the y-axis and may extend between the first vertical side 1220 and the second vertical side 1222. The gas seal 1228 may separate the main pouch 1204 from the upper pouch 1202. In examples where staggered introduction multilayer pouch 1201 does not include upper pouch 1202, gas seal 1228 may be the top seal of main pouch 1204.

The bottom seal 1224 may be produced first, and an electrode stack 1206 may be inserted within the main pouch 1204. The electrode stack 1206 may be coupled to an anode tab 1208 and a cathode tab 1210. The anode tab 1208 and the cathode tab 1210 may be metallic and may serve as contacts for external electronics to couple to the pouch cell battery 1200. A first port 1214 may be positioned above the anode tab 1208 and a second port 1216 may be positioned above the cathode tab 1210. The first port 1214 and the second port 1216 may be conical in shape and made of plastic or another material. The ports may be configured to allow chemicals to be injected from the outside of the staggered introduction multilayer pouch 1201 to the interior of the main pouch 1204. The first port 1214 and the second port 1216 may be held in position by one or more clamps while the first vertical side seal 1220 and the second vertical side seal 1222 are applied. As described with respect to 1108 of method 1100, the injection ports may be heat sealed in place within the vertical seals without the ports melting. Once the vertical side seals are formed, the top seal 1226 may be formed via heat sealing. In this way, the main pouch 1204 is sealed and the materials may enter or exit the main pouch 1204 through the first port 1214 and the second port 1216. In some examples, the injection ports may be the only aperture through which materials can enter or exit the main pouch 1204. Chemicals added to the main pouch 1204 through the ports may collect in a chemical mixture 1212 within the main pouch 1204. Chemicals may be added through the ports at any time during FA&T.

During FA&T gasses may be produced that may collect in an upper portion of the main pouch 1204. In examples where staggered introduction multilayer pouch 1201 includes and upper pouch 1202, after FA&T, the gas seal 1228 may be formed to separate the upper pouch 1202 from the main pouch 1204. The upper pouch may contain a portion of the gasses produced during FA&T, which may reduce the amount of gas within the main pouch 1204. A cut along the gas seal 1228 may separate the upper pouch 1202 from the main pouch 1204. Following separation, the upper pouch 1202 may be disposed and the main pouch 1204 may form a pouch cell battery.

Additionally or alternatively, gas produced within the main pouch 1204 during FA&T may be removed from the main pouch 1204 via one or more injection ports such as the first port 1214 and the second port 1216. In some examples, staggered introduction multilayer pouch 1201 may not include upper pouch 1202 and gas may only be removed via the or or more injection ports. In some examples, FA&T may be performed within a vacuum to facilitate the removal of gas from the main pouch 1204 via the first port 1214 and the second port 1216.

FIG. 13 shows the pouch cell battery 1200 after the first port 1214 and the second port 1216 have been thermally sealed and excess material, such as optional upper pouch 1202, has been trimmed from them. The first port 1214 may be turned into the first predetermined breaking point 1302 and the second port 1216 may be turned into the second predetermined breaking point 1304. The predetermined breaking points may serve as points of entry into the main pouch 1204 for gas removal, destructive entry into the pouch cell battery 1200, or to inject an inhibitor prior to opening the pouch cell battery 1200. In other examples, the predetermined breaking points may function to release gas from the pouch cell battery 1200 if excessive gas generation occurs.

The technical effect of methods 100, 200, and 1100 is to produce a staggered introduction multilayer pouch configured to allow one or more electrolytes or additives to be added to a pouch cell battery on demand before, during and after FA&T. Adding chemicals on demand during FA&T allows chemicals to be added as soon as they are used in the FA&T process and/or added during a stage of FA&T conducive to the chemical properties of the chemical, which may reduce chemical degradation. For example, adding electrolyte to the pouch cell battery directly before formation begins may reduce degradation in the electrolyte. In another example, adding electrochemically unstable chemicals to the pouch cell battery after formation may limit the degradation of those additives. Additionally, staggered introduction multilayer pouches manufactured according to the methods 100, 200, and 1100 may include mechanisms to remove gas produced during FA&T from the pouch cell battery, which may improve the longevity of the pouch cell battery.

The disclosure provides support for a configuration of a staggered introduction multilayered pouch cell for an energy storage device, comprising: a main pouch, the main pouch housing an electrode stack, and at least one chemical pouch adjacent to the main pouch, where the at least one chemical pouch houses a chemical compound and the main pouch and at least one chemical pouch are formed from a common sheet of multilayered pouch material, and the at least one chemical pouch is configured to add the chemical compound to the main pouch at a controlled time. In a first example of the system, the chemical pouch is fluidically sealed from the main pouch by a seal. In a second example of the system, optionally including the first example, the seal is breakable to fluidically couple the chemical pouch to the main pouch. In a third example of the system, optionally including one or both of the first and second examples, the chemical pouch is fluidically sealed from the main pouch by a sliding clamp. In a fourth example of the system, optionally including one or more or each of the first through third examples, the sliding clamp is configured to translate to selectively fluidically couple the chemical pouch to the main pouch. In a fifth example of the system, optionally including one or more or each of the first through fourth examples, the chemical pouch is fluidically sealed from the main pouch by a clamp. In a sixth example of the system, optionally including one or more or each of the first through fifth examples, the clamp is configured to fluidically couple the chemical pouch to the main pouch when unclamped.

The disclosure also provides support for a configuration of a staggered introduction multilayered pouch cell for an energy storage device, comprising: a main pouch, the main pouch housing an electrode stack, and a port positioned within a seal of the main pouch, wherein the port is configured to remain open at a main pouch sealing temperature of the main pouch and be sealed to for a sealed port at a port sealing temperature, where the port sealing temperature is higher than the main pouch sealing temperature. In a first example of the system, the port is configured to allow introduction of chemicals into the main pouch. In a second example of the system, optionally including the first example, the sealed port is configured to break above a threshold pressure within the main pouch. In a third example of the system, optionally including one or both of the first and second examples, an outer surface of the port is coated with an adhesive configured to make a fluid tight seal with the main pouch. In a fourth example of the system, optionally including one or more or each of the first through third examples, the port is a self-sealing port.

The disclosure also provides support for a method for a staggered introduction multilayered pouch cell, comprising: sealing an electrode stack within a multilayered pouch cell to form the staggered introduction multilayered pouch cell, wherein the staggered introduction multilayered pouch cell is configured for irreversible addition of additives, adding one or more additives to the staggered introduction multilayered pouch cell, and performing formation, aging, and testing of the electrode stack while adding the one or more additives to the staggered introduction multilayered pouch cell. In a first example of the method, sealing the electrode stack within the multilayered pouch cell includes placing a self-sealing port on a side of the multilayered pouch cell. In a second example of the method, optionally including the first example, adding the one or more additives to the staggered introduction multilayered pouch cell includes injecting the additives through the self-sealing port. In a third example of the method, optionally including one or both of the first and second examples, the method further comprises: heat sealing the self-sealing port after performing formation, aging, and testing and adding the one or more additives. In a fourth example of the method, optionally including one or more or each of the first through third examples, sealing the electrode stack within the multilayered pouch cell includes forming, via heat sealing and/or clamping a main pouch housing the electrode stack and a chemical pouch housing the one or more additives. In a fifth example of the method, optionally including one or more or each of the first through fourth examples, sealing the electrode stack within the multilayered pouch cell further includes adding an additive of the one or more additives to the chemical pouch before sealing to form the staggered introduction multilayered pouch cell. In a sixth example of the method, optionally including one or more or each of the first through fifth examples, adding the one or more additives includes adding from the chemical pouch to the main pouch by breaking a breakable seal or removing a clamp. In a seventh example of the method, optionally including one or more or each of the first through sixth examples, adding the one or more additives includes applying pressure to the chemical pouch to more the one or more additive from the chemical pouch to the main pouch using a roller.

FIGS. 3-10 and 12-13 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

1. A configuration of a staggered introduction multilayered pouch cell for an energy storage device, comprising:
a main pouch, the main pouch housing an electrode stack; and
at least one chemical pouch adjacent to the main pouch, where the at least one chemical pouch houses a chemical compound and the main pouch and at least one chemical pouch are formed from a common sheet of multilayered pouch material, and the at least one chemical pouch is configured to add the chemical compound to the main pouch at a controlled time.

2. The staggered introduction multilayered pouch cell of claim 1, wherein the chemical pouch is fluidically sealed from the main pouch by a seal.

3. The staggered introduction multilayered pouch cell of claim 2, wherein the seal is breakable to fluidically couple the chemical pouch to the main pouch.

4. The staggered introduction multilayered pouch cell of claim 1, wherein the chemical pouch is fluidically sealed from the main pouch by a sliding clamp.

5. The staggered introduction multilayered pouch cell of claim 4, wherein the sliding clamp is configured to translate to selectively fluidically couple the chemical pouch to the main pouch.

6. The staggered introduction multilayered pouch cell of claim 1, wherein the chemical pouch is fluidically sealed from the main pouch by a clamp.

7. The staggered introduction multilayered pouch cell of claim 6, wherein the clamp is configured to fluidically couple the chemical pouch to the main pouch when unclamped.

8. A configuration of a staggered introduction multilayered pouch cell for an energy storage device, comprising:
a main pouch, the main pouch housing an electrode stack; and
a port positioned within a seal of the main pouch, wherein the port is configured to remain open at a main pouch sealing temperature of the main pouch and be sealed at a port sealing temperature, where the port sealing temperature is higher than the main pouch sealing temperature.

9. The staggered introduction multilayered pouch cell of claim 8, wherein the port is configured to allow introduction of chemicals into the main pouch.

10. The staggered introduction multilayered pouch cell of claim 8, wherein a sealed port is configured to break above a threshold pressure within the main pouch.

11. The staggered introduction multilayered pouch cell of claim 8, wherein an outer surface of the port is coated with an adhesive configured to make a fluid tight seal with the main pouch.

12. The staggered introduction multilayered pouch cell of claim 8, wherein the port is a self-sealing port.

13. A method for a staggered introduction multilayered pouch cell, comprising:
sealing an electrode stack within a multilayered pouch cell to form the staggered introduction multilayered pouch cell, wherein the staggered introduction multilayered pouch cell is configured for irreversible addition of additives;
adding one or more additives to the staggered introduction multilayered pouch cell; and
performing formation, aging, and testing of the electrode stack while adding the one or more additives to the staggered introduction multilayered pouch cell.

14. The method of claim 13, wherein sealing the electrode stack within the multilayered pouch cell includes placing a self-sealing port on a side of the multilayered pouch cell.

15. The method of claim 14, wherein adding the one or more additives to the staggered introduction multilayered pouch cell includes injecting the additives through the self-sealing port.

16. The method of claim 14, further comprising heat sealing the self-sealing port after performing formation, aging, and testing and adding the one or more additives.

17. The method of claim 13, wherein sealing the electrode stack within the multilayered pouch cell includes forming, via heat sealing and/or clamping a main pouch housing the electrode stack and a chemical pouch housing the one or more additives.

18. The method of claim 17, wherein sealing the electrode stack within the multilayered pouch cell further includes adding an additive of the one or more additives to the chemical pouch before sealing to form the staggered introduction multilayered pouch cell.

19. The method of claim 17, wherein adding the one or more additives includes adding from the chemical pouch to the main pouch by breaking a breakable seal or removing a clamp.

20. The method of claim 17, wherein adding the one or more additives includes applying pressure to the chemical pouch to more the one or more additive from the chemical pouch to the main pouch using a roller.
